(19) United States
(12) Patent Application Publication
(10) Pub. No.: US 2024/0421511 A1
(43) Pub. Date: Dec. 19, 2024

(54) TRUNK BUS SYSTEM

(71) Applicant: Voltage, LLC, Chapel Hill, NC (US)

(72) Inventors: Ruiyan GE, Ningbo (CN); Li WANG, Ningbo (CN)

(21) Appl. No.: 18/805,928

(22) Filed: Aug. 15, 2024

Related U.S. Application Data
(63) Continuation-in-part of application No. 17/870,307, filed on Jul. 21, 2022.
(60) Provisional application No. 63/224,631, filed on Jul. 22, 2021.

(51) Int. Cl. H01R 4/70; H01R 4/18; H01R 9/03; H02G 15/10

(52) U.S. Cl. CPC H01R 4/70; H01R 4/183; H01R 4/188; H01R 9/03; H02G 15/10

(57) ABSTRACT

A trunk bus connector for electrically coupling one or more branch cables to a trunk line may comprise a junction area where one or more stripped portions of the branch cable(s) can be secured against a stripped portion of the trunk line. The trunk bus connector may comprise an overmold substantially encapsulating the junction area and comprising a trunk line pathway to enable the trunk line to pass through the junction area. The overmold may comprise one or more branch entry pathways to enable the branch cable(s) access into the junction area. Each branch entry pathway may be angled with respect to the trunk line pathway such that the branch cable(s) enter into the junction area such that an angle at which each branch cable approaches the trunk line is between approximately 30 and 50 degrees.

### CROSS-REFERENCE TO RELATED APPLICATIONS

This application is a continuation-in-part of U.S. Non-Provisional application Ser. No. 17/870,307, filed Jul. 21, 2022, titled “TRUNK BUS SYSTEM,” which claims the benefit and priority of U.S. Provisional Application No. 63/224,631, filed on Jul. 22, 2021, entitled “TRUNK BUS SYSTEM.” Both of these applications are incorporated by reference herein, in their entirety, for all purposes.

### FIELD OF THE DISCLOSURE

The present disclosure is related generally to the collection of solar power and efficient transmission of captured solar-generated electricity to one or more inverters for delivery to a power grid, energy storage device, and/or another electric consumer. More particularly, in some embodiments, the present disclosure relates to a trunk bus system that may enable better connection of one or more solar panels to an inverter or other electrical component.

### BACKGROUND

Solar panels have long been used to capture energy from the sun and convert the energy into electricity, specifically, direct current (DC) electricity. In many applications, the electricity from a panel or several panels may be delivered to an energy storage device (e.g., battery) or other electrical component that may convert, store, or otherwise use the energy. When the generated electricity is to be provided to an alternating current (AC) system (e.g., electric grid, household, etc.), deliver the electricity collected by solar panel(s) to an inverter that converts the electricity from DC to AC and passes the AC electricity onto the consumer (grid, household, etc.).

One conventional method of installing solar power DC wires is to connect a plurality of conducting (e.g., copper) photovoltaic extender wires from solar strings to a combiner box, and then combine several DC feeder lines from combiner boxes to an inverter. To implement this method, on-site technicians must pull the wires, cut the wires to length, crimp connectors, and connect to the combiner boxes. Another method involves using a thick cable, called a trunk bus or trunk line, to carry electricity collected from multiple solar panels to an inverter, where individual strings of solar panels connect to the trunk bus at designated points.

### BRIEF SUMMARY

A trunk bus connector for electrically coupling one or more branch cables to a trunk line may comprise a region of electrical contact where one or more stripped portions of the one or more branch cables can be secured by the connector against a stripped portion of the trunk line to electrically couple the one or more branch cables to the trunk line. The trunk bus connector may comprise an overmold substantially encapsulating the region of electrical contact and comprising a trunk line pathway to enable the trunk line to pass through the region of electrical contact. The overmold may comprise one or more branch entry pathways to enable the one or more branch cables access into the region of electrical contact. Each of the one or more branch entry pathways may be angled with respect to the trunk line pathway such that the branch cable(s) enter into the region of electrical contact such that the one or more branch cables enter into the region of electrical contact to be coupled with the trunk line such that an angle at which each branch cable approaches the trunk line is between approximately 30 and 50 degrees. Embodiments of the trunk bus connector may include a crimp configured to secure the stripped portion(s) of the branch cable(s) and the stripped portion of the trunk line together. The crimp may comprise a substantially tubular body forming a channel through which the stripped portion of the trunk line can pass. The crimp may comprise two semi-cylindrical members that, when mated, form the tubular body, and helical and/or straight grooves for stripped portion(s) of the branch cable(s) may run along the channel to secure the stripped portion(s) of the branch cable(s) in the grooves to the stripped portion of the trunk line in the channel.

According to this disclosure, an example method of electrically coupling one or more branch cables to a trunk line may include stripping a portion of the trunk line and stripping one or more portions of the one or more branch cables to be electrically coupled to the trunk line. The method may further include a connector on the trunk line. The connector may comprise a region of electrical contact where one or more stripped portions of the one or more branch cables can be secured by the connector against a stripped portion of the trunk line to electrically couple the one or more branch cables to the trunk line, and an overmold substantially encapsulating the region of electrical contact, the overmold comprising a trunk line pathway to enable the trunk line to pass through the region of electrical contact and one or more branch entry pathways to enable the one or more branch cables access into the region of electrical contact. Each of the one or more branch entry pathways may be angled with respect to the trunk line pathway such that the one or more branch cables enter into the region of electrical contact to be coupled with the trunk line such that an angle at which each branch cable of the one or more branch cables approaches the trunk line is between approximately 30 and 50 degrees. The method may further comprise placing the one or more stripped portions of the one or more branch cables into the connector, and securing the connector to electrically couple the one or more branch cables to the trunk line.

According to this disclosure, an example crimp for electrically coupling one or more branch cables to a trunk line may comprise a substantially tubular body configured to secure one or more stripped portions of the one or more branch cables and the stripped portion of the trunk line together. The tubular body may form a channel through which the stripped portion of the trunk line can pass. Further, the crimp may comprise two semi-cylindrical members that, when mated, form the tubular body. The tubular body may further comprise one or more grooves alongside the channel for the stripped portions of the one or more branch cables. The one or more grooves may be configured to secure the one or more stripped portions of the one or more branch cables against the stripped portion of the trunk line in the channel.

This summary is neither intended to identify key or essential features of the claimed subject matter nor is it intended to be used in isolation to determine the scope of the claimed subject matter. The subject matter should be understood by reference to appropriate portions of the entire specification of this disclosure, any or all drawings, and each claim. The foregoing and other features and examples will be described in more detail below in the following specification, claims, and accompanying drawings.

### BRIEF DESCRIPTION OF THE DRAWINGS

FIG. 1 illustrates a top view of an overmold of an example of a trunk bus device, according to an embodiment.

FIG. 2 illustrates a bottom view of the overmold illustrated in FIG. 1.

FIG. 3 illustrates a side view of the overmold illustrated in FIG. 1.

FIG. 4 illustrates an end view of the overmold illustrated in FIG. 1.

FIGS. 5A and 5B illustrate exemplary dimensions of the overmold of the disclosed trunk bus device shown in FIGS. 1-4, though embodiments may be of any size/dimensions desired for any particular system or implementation.

FIG. 6 illustrates an exemplary instance of a branch line being coupled to a trunk line within an undermold located inside a trunk bus device, according to an embodiment.

FIGS. 7A-7F illustrate some exemplary arrangements of branch cables entering the undermold of a trunk bus to be coupled to a trunk line, according to some embodiments.

FIGS. 8A-8D illustrate the side, bottom, backside, and end view of the undermold portion of a trunk bus device, according to an embodiment.

FIG. 9 is an illustration of an example location of a trunk device shown relative to the overall architecture of a solar farm, according to an embodiment.

FIG. 10 illustrates a more detailed example of how multiple trunk busses may be incorporated into the overall architecture of a solar farm, thereby allowing multiple panels to transfer power to the main trunk lines, according to an embodiment.

FIG. 11 illustrates an additional example of multiple trunk busses incorporated into the overall architecture of a solar farm, thereby allowing multiple panels to transfer power to the main trunk lines.

FIG. 12 is an illustration of an example trunk bus connector capable of accommodating different configurations of branch cables, according to an embodiment.

FIGS. 13A-13F are illustrations of a set of example configurations in which an overmold of a trunk bus connector has four branch cable ports.

FIGS. 14A-14C are illustrations of a set of example configurations in which an overmold of a trunk bus connector has three branch cable ports.

FIGS. 15A-15D are illustrations of a set of example configurations in which an overmold of a trunk bus connector has two branch cable ports.

FIG. 16 is an illustration of an undermold of the example trunk bus connector of FIG. 12, according to an embodiment.

FIG. 17 is an illustration of a crimp of the example trunk bus connector of FIG. 12, according to an embodiment.

FIGS. 18A and 18B are illustrations of a configuration of two branch cables and a trunk line, prior to crimping, according to an embodiment.

FIGS. 19A and 19B are illustrations of a crimp, according to a first embodiment.

FIGS. 20A and 20B are illustrations of perspective and side views of a crimp, respectively, according to a second embodiment

FIG. 21 is a flow diagram of a method of electrically coupling one or more branch cables to a trunk line, according to an embodiment.

### DETAILED DESCRIPTION

The presently disclosed subject matter now will be described more fully hereinafter with reference to the accompanying Figures, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

As noted, one conventional method of installing solar power DC wires is to connect a plurality of conducting (e.g., copper) photovoltaic extender wires from solar strings to a combiner box, and then combine several DC feeder lines from combiner boxes to an inverter. To implement this method, on-site technicians must pull the wires, cut the wires to length, crimp connectors, and connect to the combiner boxes. This process is very labor-intensive and time-consuming, and the quality of work is very low and inconsistent. Additionally, existing wiring harnesses used to make the connections are labor intensive and yield failed and broken connections that often require rework.

Further complicating matters, more recently, many solar module manufacturers are launching high-wattage power solar panels. Such panels have lower voltage at maximum power (Vmp) but higher short circuit current (Isc). Using existing wiring harnesses and methods, #6AWG copper PV wire, for example, will be required, substantially increasing costs and adding to the Capex value of the solar installation. In addition, due to exposure to severe weather at most sites, combiner boxes installed on-site often malfunction, requiring additional intensive maintenance. Furthermore, to better take advantage of the land, most sites try to go with higher numbers of trackers in a row. However, solar sites are currently limited to 3 or 4 trackers due to DC loss requirements.

Previously, certain trunk busses have been utilized that employ a parallel structure. Disadvantageously, in previous designs, the branch cable (smaller wire) must be bent at least twice: one (approx.) 90-degree bend to move the branch cable conductor down to the trunk line (larger wire) and a second (approx.) 90-degree bend to align the branch cable with the trunk line to facilitate electrical contact between the two. These multiple abrupt bends can lead to wire breaks, complicate installation, and add costs to installation, among other problems.

Embodiments herein address these and other issues by providing a trunk bus system that may be used to electrically connect solar panels and inverters (or other receivers of solar-generated electricity or other electricity) without the need for combiner boxes or the associated combiner box maintenance and installation. By way of just one example, a trunk bus feeder/trunk may be made using 2 kV aluminum photovoltaic wire and may range in sizes from 4/0 to 1000 MCM, but larger or smaller sizes are also contemplated.

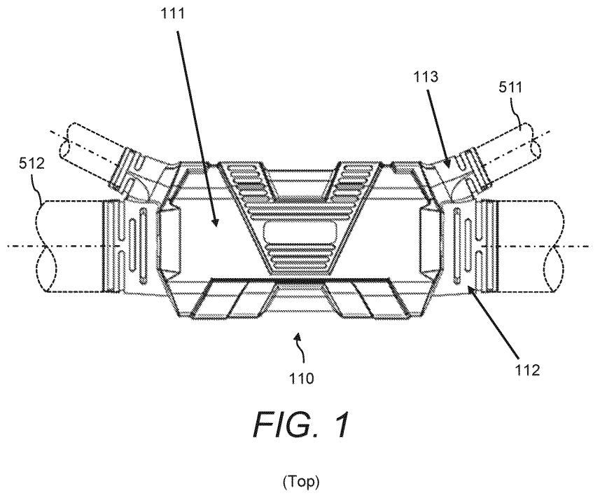

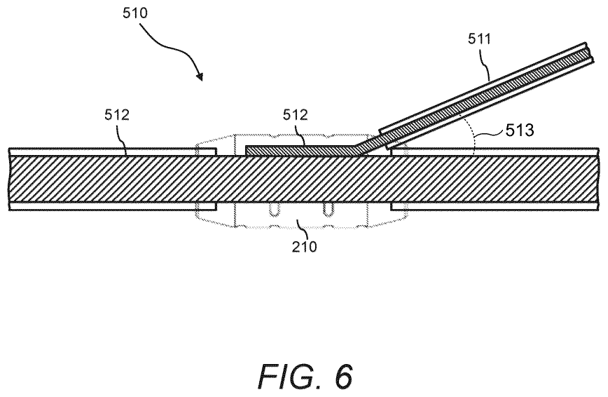

Referring now to FIG. 1, a top view of an embodiment of a trunk bus 110 is presented. In certain embodiments, the trunk bus 110 may include an undermold layer 210 (shown in FIG. 6), an overmold layer 111 (which also may be referred to as an “outermold”), a trunk line through port 112 wherein one or more trunk lines 512 run through, and one or more branch line entry ports 113 wherein one or more branch lines 511 enter the trunk bus.

The branch lines 511 (smaller lines in the figures) may connect to solar panels, and the trunk line 512 (e.g., the larger, central cable running through the joint, also known as a feeder cable) may be connected to an inverter or to a disconnect box or other electricity receiving device/component, which may, in some embodiments, include a switch and/or fuse protection. By using the trunk bus system, the usage of copper string wires, for example, may be minimized, and larger-size aluminum wires (sizing according to National Electrical Code (NEC) requirements), which are more cost-efficient than copper string wires, may also be utilized. Further, the need for combiner boxes and combiner boxes installation and maintenance can be eliminated. Since, in some embodiments, the main trunk/feeder size can be as large as 1000 MCM, for example, solar farms may exceed more than 4 or 5 high trackers while maintaining DC loss requirements.

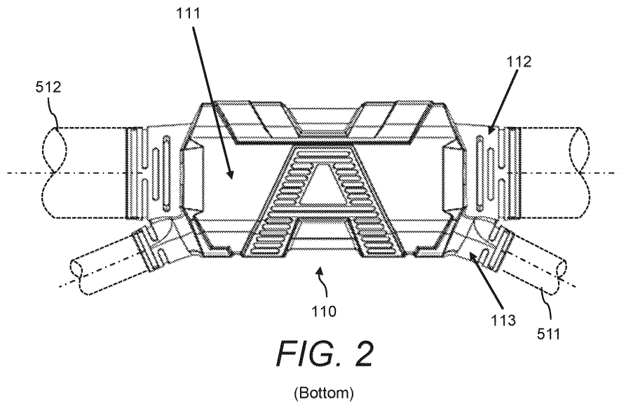

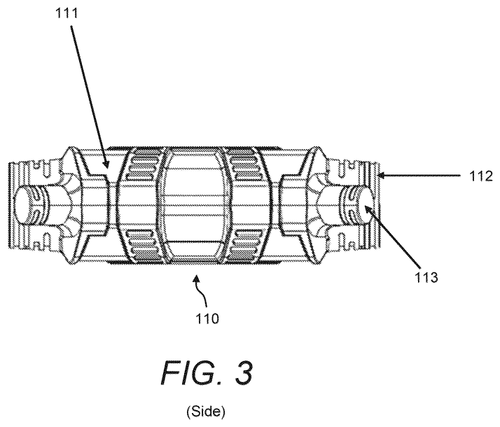

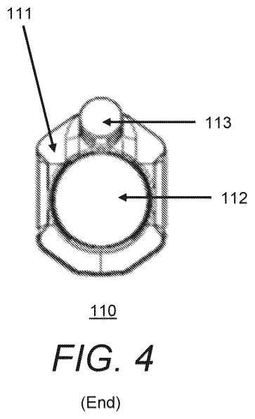

Referring now to FIGS. 2, 3, and 4, a bottom, side, and end view of an embodiment of the trunk bus 110 is presented, respectively. Notably, each view includes an overmold layer 111, a trunk line through port 112 wherein one or more trunk lines 512 run through, and one or more branch line entry ports 113 wherein one or more branch lines 511 enter the trunk bus 110.

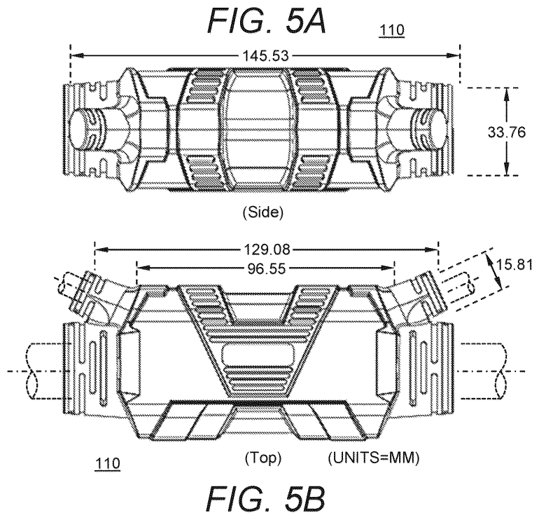

FIG. 5A and FIG. 5B both display exemplary dimensions of the overmold 111 of the embodiment of the trunk bus 110 device shown in FIGS. 1-4.

Those skilled in the art will appreciate that embodiments of a trunk bus as provided in this disclosure can eliminate several disadvantages with the parallel connectors commonly found in the prior art. As illustrated in FIG. 6, for example, the junction zone 510 within the trunk bus connector may provide for entry of the branch cable 511 at an angle 513, rather than parallel to the trunk line 512, for example, approximately 45 degrees (though other angles are contemplated). One advantage is the elimination of multiple 90-degree bends necessitated by connectors of the prior art. Instead, the branch cable 511 requires only a single, substantially less than 90-degree bend, thereby eliminating stress on the branch cable 511, reducing the number of wire breaks during installation, and simplifying installation overall. The inclined or angled approach shown for example in FIG. 6 also allows for a greater bending radius of the branch cable 511 overall, which further protects the branch cable 511 and reduces installation issues and breaks. Additionally, the inclined or angled approach shown for example in FIG. 6 further allows for the branch cables 511 to be shorter, further reducing installation and material costs. Utilizing only a single bend, the branch cable 511 may approach and lay flat against the trunk line 512 to be electrically coupled in the area within the undermold 210.

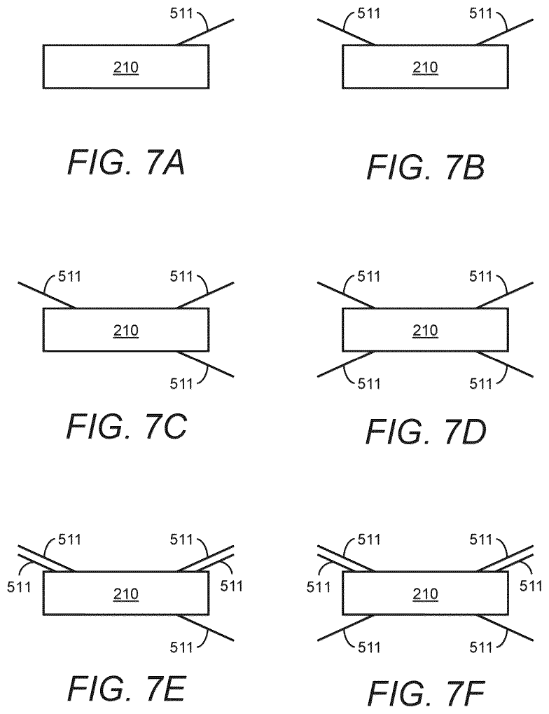

FIGS. 7A-7F illustrate certain embodiments of undermold 210 and branch line 511 arrangements. Modifications to the overmold 111 (not shown in FIGS. 7A-F) and undermold 210 allow for the preferred, inclined installation approach taught by this disclosure. In certain embodiments, the undermold 210 may be manufactured with various dimensions so that multiple different size branch cables 511 may be accommodated, while still only necessitating a single bend in the branch cables 511. In certain other embodiments, the overmold may include multiple branch line entry ports so as to accommodate the coupling of one or more branch cables 511 to a single trunk line 512, thereby resulting in reduced cost, increased efficiency, and easier installation and maintenance of the trunk bus system when utilized in solar electricity generation arrays. It should be noted that there are numerous examples of the number and arrangement of trunk lines 511 that may enter the undermold 210 depending on the specific need within the electricity generation array, some of which may not be present in FIG. 7A-7F but are nonetheless inherently present in the design and this disclosure.

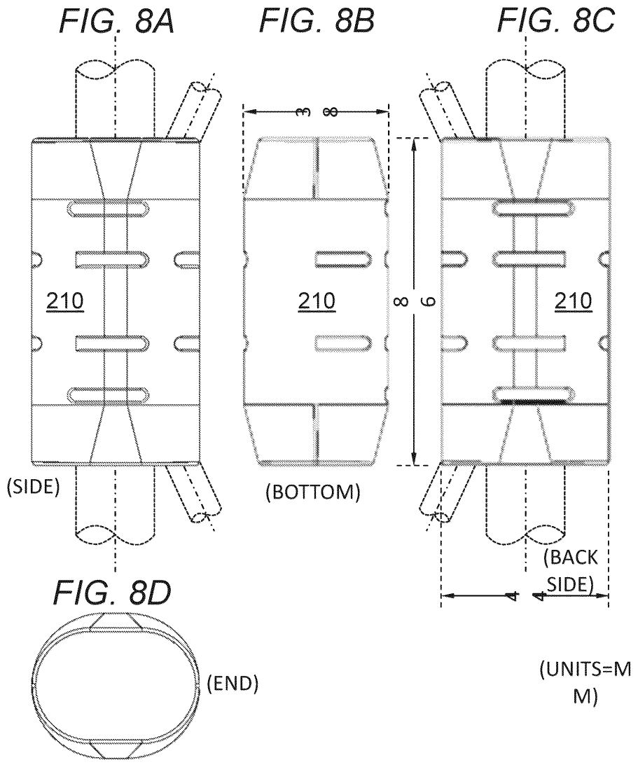

Referring now to FIG. 8A-8D, side, bottom, backside, and end views of an embodiment of an undermold 210 with exemplary dimensions are presented. It should be noted that other examples of the undermold 210 may also be contemplated to accommodate the potential arrangements of branch cables 511 displayed and contemplated in FIG. 7A-7F.

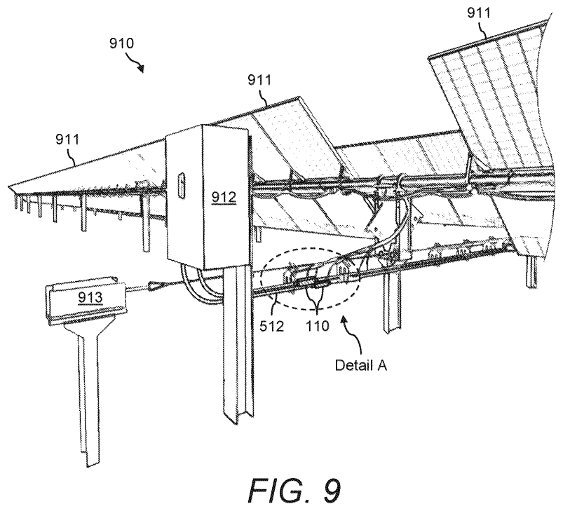

FIG. 9 is an illustration that presents an exemplary location of trunk bus devices 110 disclosed herein, shown relative to the overall architecture of a solar farm 910 or electricity generation array as they might be installed and used in the field. Those skilled in the art will appreciate that an exemplary trunk bus device 110 is illustrated with multiple branch cables 511 extending to multiple solar panels 911. Advantageously, the inclined branch cable installation enables case of installation, and better protects the branch cables by allowing for fewer bends of the conductor metal in the connector, and increase bend radius of the branch cable, among other things. Also present in FIG. 9 is an electrical disconnect box 912 and an inverter 913, both of which are commonly found electrical components necessary for solar array operation.

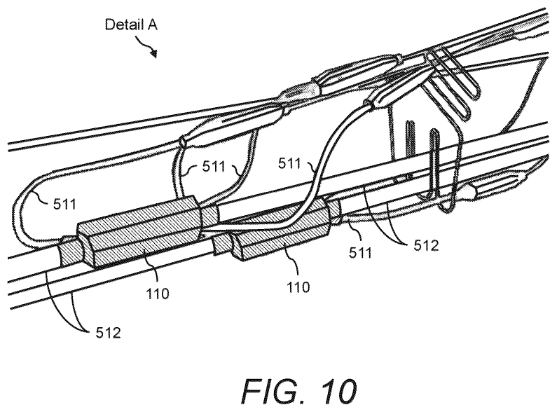

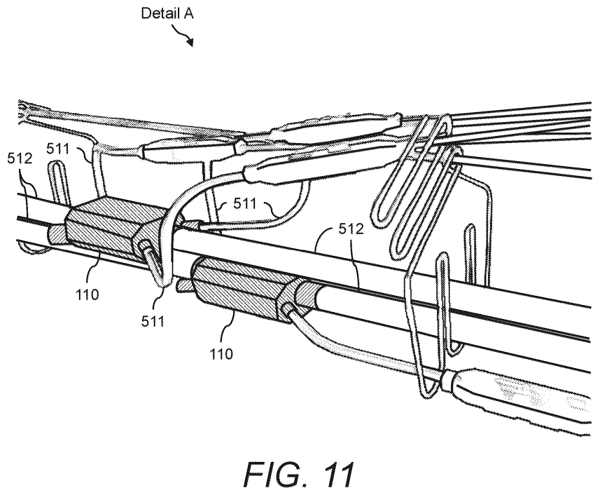

FIGS. 10 and 11 are illustrations of closer views of the portion of FIG. 9 designated as Detail A. This portion is of particular interest because it illustrates an exemplary instance of how the presently disclosed trunk bus device 110 may be arranged for use in a solar array. Particular attention should be directed at how numerous branch lines 511 may feed into the trunk bus device 110, and that multiple trunk bus devices 110 may be located on a trunk line 512. This broader implementation of the presently disclosed trunk bus devices 110 allows the electrical current produced by multiple solar panels to be consolidated into a single trunk line 512 before being transferred for further processing.

As noted previously (e.g. in FIGS. 7A-7F), different embodiments may accommodate various configurations for coupling one or more branch cables 511 to a trunk line 512. Further, a single type of bus connector may be capable of accommodating different configurations.

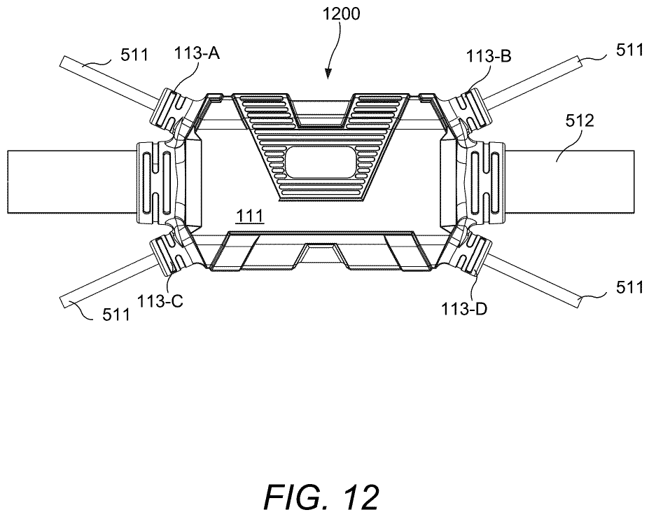

FIG. 12 is an illustration of an example trunk bus connector 1200 capable of accommodating different configurations of branch cables, depending on desired functionality. In this example, the trunk bus connector 1200 includes and overmold 111 with four branch cable ports 113-A, 113-B, 113-C, and 113-D (also referred to herein as branch entry pathways or entry ports), enabling up to four branch cables 511 to couple with a trunk line 512 in a junction area, or region of electrical contact, substantially encapsulated by the trunk bus connector's overmold 111. As previously discussed, portions of the branch cables 511 and trunk line 512 within the trunk bus connector 1200 may be stripped (of the insulator material) to allow electrical coupling of the branch cables 511 and trunk line 512 in a junction area substantially encapsulated by the overmold 111.

The material(s) with which the overmold 111 is made may vary, depending on desired functionality. These materials may comprise UV-and weather-resistant materials be selected to help protect the electrical connection(s) from moisture intrusion and corrosion. According to some embodiments these materials may include polyvinyl chloride (PVC), nylon, polycarbonate, silicone rubber, other weatherproof plastics, and/or the like. Materials may be selected, for example, to have a flammability rating of V-1 or above, an outdoor suitability rating of f1, a hot-wire ignition (HWI) rating of 4 or less, a high amp arc ignition (HAI) rating of 3 or less, a relative thermal index (RTI) of 90° C. or more, and a comparative tracking index (CTI) of 2 or less. Santoprene® thermoplastic vulcanizate (TPV), a material produced by Celanese International Corp. of Florence, Kentucky (USA), is one such material.

As described in more detail below, depending on a desired configuration, branch cables 511 may form terminal connections and/or through connections with the trunk line 512. As described herein, a “terminal” connection may be formed when a branch cable 511 ends inside the trunk bus connector 1200. An example of this is illustrated in FIG. 6, described above. In FIG. 12, the trunk bus connector 1200 may have up to four terminal connections. That is, each branch cable 511 entering a respective branch cable port 113-A, 113-B, 113-C, or 113-D may comprise a separate branch cable that is electrically coupled with the trunk line 512 and terminates inside the trunk bus connector 1200.

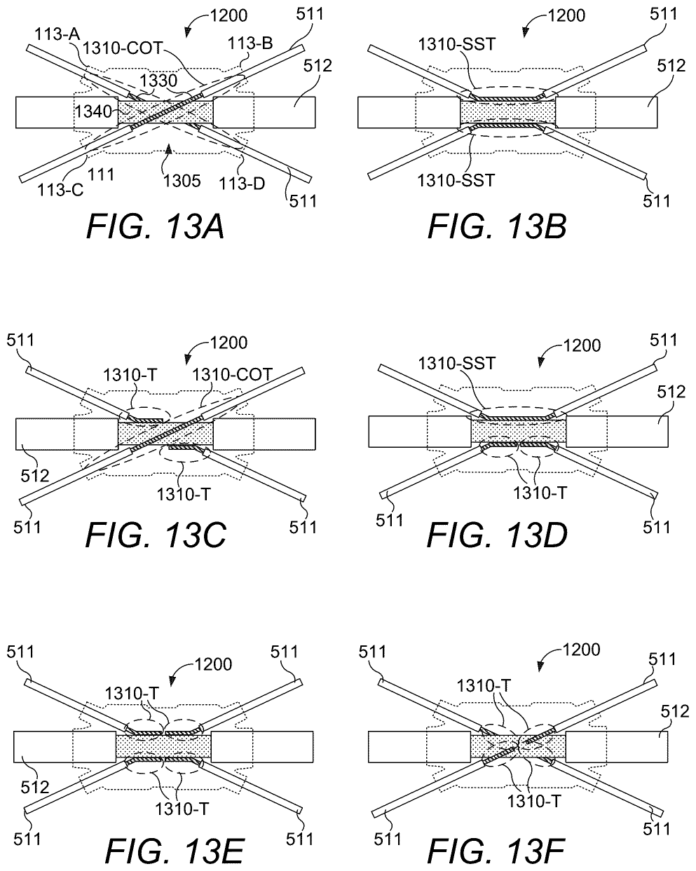

Additionally, or alternatively, branch cables 511 may represent “through” connections, where a single branch cable 511 enters one branch cable port 113 and exits another. For example, a branch cable 511 may enter the trunk bus connector 1200 at branch cable port 113-A and exit the trunk bus connector 1200 at branch cable port 113-D. This type of through connection, in which the branch cable 511 enters a trunk bus connector 1200 on one side of the trunk line 512 and exits the trunk bus connector 1200 on the other side of the trunk line 512, is referred to herein as a “crossover” through connection. A branch cable 511 entering branch cable port 113-C and exiting the trunk bus connector 1200 at branch cable port 113-B also represents a crossover through connection. In another example, a branch cable 511 may enter the trunk bus connector 1200 at branch cable port 113-A and exit the trunk bus connector 1200 at branch cable port 113-B. This type of through connection, in which the branch cable 511 enters a trunk bus connector 1200 on one side of the trunk line 512 and exits the trunk bus connector 1200 on the same side of the trunk line 512, is referred to herein as a “same-side” through connection. As described below with respect to FIGS. 13A-15B, trunk bus connectors (e.g., trunk bus connectors 110 or 1200) with overmolds 111 having different numbers of branch cable port 113 can accommodate various types of configurations.

FIGS. 13A-13F illustrate a set of configurations in which an overmold 111 of a trunk bus connector 1200 has four branch cable ports 113-A, 113-B, 113-C, and 113-D. (FIG. 13A includes various labels that are omitted in FIGS. 13B-13F, to avoid clutter, but which are applicable to corresponding features.) It can be noted that the trunk bus connector 1200 may also include an undermold and/or crimp, neither of which are illustrated in FIGS. 13B-13F. According to some embodiments, some undermolds and/or crimps may be designed to support particular configurations. Additionally, or alternatively, undermolds and/or crimps may be designed to support multiple configurations. Additional details regarding such designs are provided hereafter. Additionally labeled in FIGS. 13A-13F are junction areas 1305, also referred to herein as regions of electrical contact, in which stripped portions (exposed conductors) of branch cables 1330 lay against a stripped portion of the trunk line 1340 to electrically couple the branch cables 511 to the trunk line 512. Various types of connections are identified with dashed lines, where crossover through connections are labeled 1320-COT, same-side through connections are labeled 1320-SST, and terminal connections are labeled 1320-T. Finally, it can be noted that FIGS. 13A-13F are provided as examples and may not represent all configurations in which an overmold 111 of a trunk bus connector 1200 has four branch cable ports 113-A, 113-B, 113-C, and 113-D.

As illustrated, configurations may include a combination of through and terminal connections. FIG. 13A illustrates a configuration in which two branch cables 511 form crossover through connections 1310-COT with the trunk line 512. FIG. 13B illustrates a configuration in which two branch cables 511 form same-side connections 1310-SST with the trunk line 512. FIG. 13C illustrates a configuration in which three branch cables 511 form two terminal connections 1310-T and one crossover through connection 1310-COT. FIG. 13D illustrates a configuration in which three branch cables 511 form two terminal connections 1310-T and one same-side through connection 1310-SST. FIG. 13E illustrates a configuration with four branch cables 511 and four terminal connections 1310-T with trunk line 512. Finally, FIG. 13F, which also shows a configuration in which four branch cables 511 form four terminal connections 1310-T with trunk line 512, is provided to illustrate an example of alternative terminal connections which differ from the terminal connections 1310-T of FIGS. 13B-13E. Specifically, rather than a terminal connection 1310-T in which a portion of the branch cable 511 runs parallel to the trunk line 512, the configuration in FIG. 13F (and other configurations not illustrated) may include one or more terminal connections 1310-T in which a portion of the branch cable 511 runs helically around at least a portion of the trunk line 512. (Additional details regarding how such helical connections may be formed are provided below.)

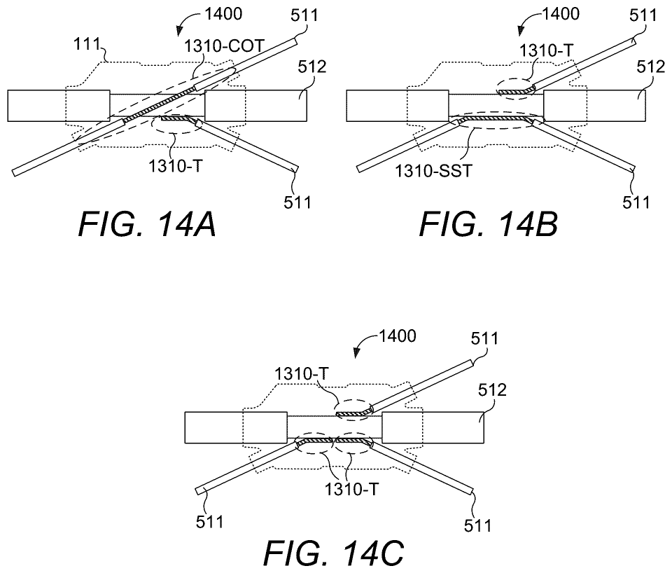

FIGS. 14A-14C illustrate a set of configurations that extend aspects of the examples illustrated in FIGS. 13A-13F to a trunk bus connector 1400 having an overmold 111 with three branch cable ports. Similar to FIGS. 13A-13F the trunk bus connector 1400 may include an undermold and/or crimp, neither of which are illustrated in FIGS. 14A-14C. Further, it can be noted that FIGS. 14A-14C are provided as examples and may not represent all configurations in which an overmold 111 of a trunk bus connector 1400 has three branch cable ports.

As illustrated, configurations may include a combination of through and terminal connections. FIG. 14A illustrates a configuration in which two branch cables 511 form a crossover through connection 1310-COT and a terminal connection 1310-T with the trunk line 512. FIG. 14B illustrates a configuration in which two branch cables 511 form a same-side through connection 1310-SST and a terminal connection 1310-T with the trunk line 512. FIG. 14C illustrates a configuration in which three branch cables 511 form three terminal connections 1310-T with the trunk line 512.

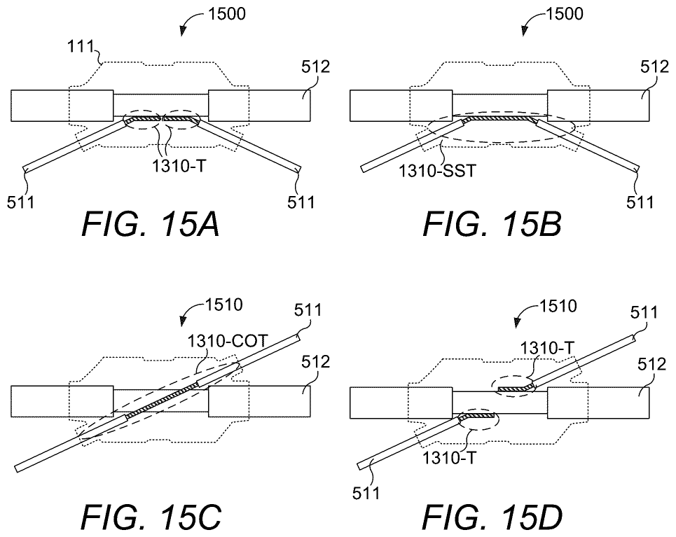

FIGS. 15A-15D illustrate a set of configurations that extend aspects of the examples illustrated in FIGS. 13A-14C to two types of trunk bus connectors 1500 and 1510 having an overmold 111 with two branch cable ports. In particular, FIGS. 15A and 15B illustrate a trunk bus connector 1500 of a first type in which the overmold 111 has two branch cable ports on the same side of the trunk line 512 (similar to embodiment illustrated in FIG. 1). FIGS. 15C and 15D illustrate a trunk bus connector 1510 of a second type in which the overmold 111 has two branch cable ports on opposite sides of the trunk line 512. Similar to FIGS. 13A-14C the trunk bus connectors 1500 and 1510 may include an undermold and/or crimp, neither of which are illustrated in FIGS. 15A-15D. Further, it can be noted that FIGS. 15A-15D are provided as examples and may not represent all configurations in which an overmold 111 of a trunk bus connectors 1500 and 1510 have two branch cable ports.

As illustrated, configurations may include a combination of through and terminal connections. FIG. 15A illustrates a configuration in which two branch cables 511 form terminal connections 1310-T with the trunk line 512. FIG. 15B illustrates a configuration in which a single branch cable 511 forms a same-side through connection 1310-SST. FIG. 15C illustrates a configuration in which a single branch cable 511 forms a crossover through connection 1310-COT with the trunk line 512. FIG. 15 D illustrates a configuration in which two branch cables 511 form terminal connections 1310-T with the trunk line 512.

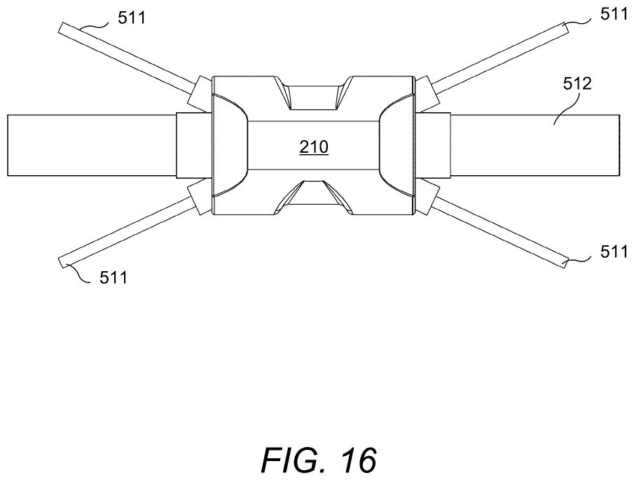

As noted above, a trunk bus connector may include an undermold and/or crimp, which may be encapsulated by the open mobile. Returning to FIG. 12, for example, trunk bus connector 1200 may encapsulate an undermold and/or crimp configured to secure the connections between the branch cables 511 and trunk line 512. FIGS. 16-20, described below, illustrate examples of an undermold and/or crimp that may be used with a trunk bus connector 1200 having an overmold 111 with four branch cable ports. It can be noted, however, that the principles described below can be applied to trunk bus connectors having a different number of branch cable ports, such as trunk bus connectors 1400, 1500, and 1510, illustrated in FIGS. 14A-15D.

FIG. 16 is an illustration of an undermold 210 of the example trunk bus connector 1200 of FIG. 12. The material(s) with which the undermold 210 is made may vary, depending on desired functionality. Because the undermold 210 is substantially encapsulated by the overmold 111, the materials of the undermold 210 need not necessarily be UV-or weather-resistant. Materials be selected to help secure branch cables 511 to trunk line 512. According to some embodiments, these materials may include materials that have a flammability rating of V-1 or above. Again, Santoprene® TPV is one such material.

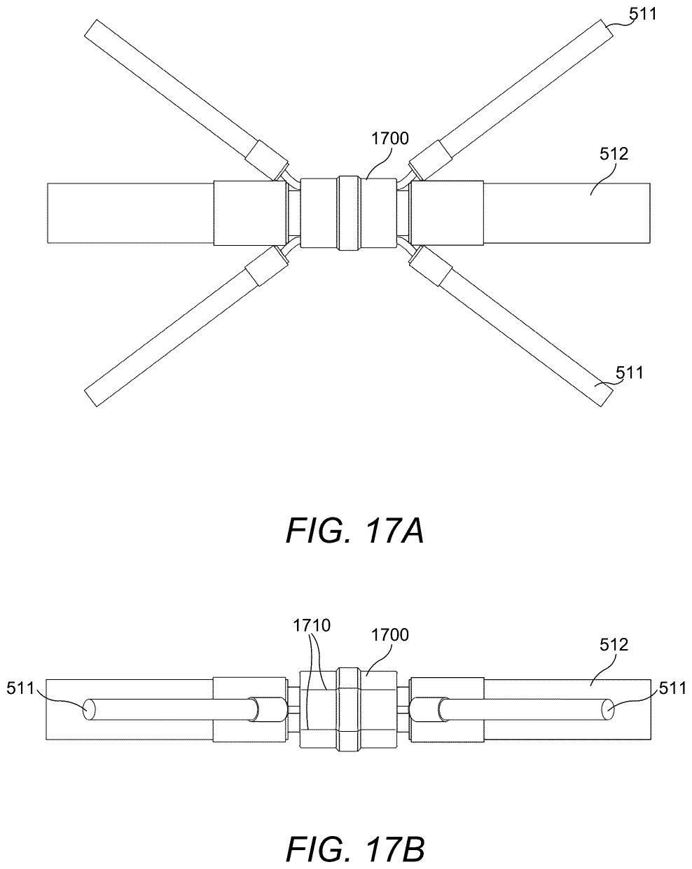

FIGS. 17A and 17B are illustrations of a crimp 1700 of the example trunk bus connector 1200 of FIG. 12 (after crimping has taken place). Note that the illustration in FIG. 17A shows a view similar to FIG. 12 (e.g., a top (plan) view), and the illustration in FIG. 17B shows a rotated view (e.g., a front view). In some embodiments, the crimp 1700 may be substantially encapsulated by the undermold 210 of FIG. 16. Additionally or alternatively, as noted, the crimp 1700 may be substantially encapsulated by the overmold 111 without the use of an undermold. The crimp 1700 may be made of a conductive material (such as aluminum, copper, or steel) that holds its shape when a crimping force is applied to press and secure stripped portions of the branch cables 511 to the trunk line 512. As previously noted, the crimp 1700 may be designed to accommodate one or more different configurations, such as the configurations illustrated in FIGS. 13A-13F. Additional details regarding one such design are provided below. (The design discussed below comprises a smaller c-crimp coupled with a larger c-crimp. Seams 1710 illustrated in FIG. 17B show the boundaries of these two pieces after crimping.)

In addition or as an alternative to using an overmold, undermold, or both to protect and insulate electrical connections of a trunk bus system as described above, some embodiments may use one or more temperature-activated sealing members, such as a heat shrink tube (HST). In some embodiments, an HST may comprise a thermoplastic member, generally tubular or cylindrical, although variations in shape may be implemented for specific applications. When placed over and underlying structure such as a stripped portion of a wire or cable (and optionally overlapping with an un-stripped portion), applied heat may cause the outer layer of the HST to shrink and conform to an outer shape of the stripped (and optionally un-stripped) portion(s) of the wire or cable. Because of this tight encapsulation of the underlying wire or cable, an HST may provide a hermetic seal that prevents undesirable elements such as moisture, dust, and air from coming into contact with the encapsulated portion(s) of the wire or cable. HSTs may also help provide electrical insulation for stripped portions of the wire or cable encapsulated therewith. As such, HSTs may be used at various locations in a trunk bus system, including at locations where portions of branch cables and/or a trunk line are stripped and crimped (e.g., as illustrated in FIGS. 17A and 17B). It can be noted that HSTs are not necessarily limited to encapsulating wire or cable, but may be configured to encapsulate other structures, including, for example, all or a portion of a (e.g., crimp 1700). HSTs may be manufactured from a variety of thermoplastic materials, such as polyolefins (e.g., polyethylene (PE) and polypropylene (PP)), fluoropolymers (e.g., polytetrafluoroethylene (PTFE), fluorinated ethylene propylene (FEP), and polyvinylidene fluoride (PVDF)), polyvinyl chloride (PVC), or the like. Further, an HST may be selected based on specific constraints, such as physical dimensions, fire-retardation rating, electrical resistance, physical dimensions shrinkage range, and/or other parameters.

Depending on desired functionality, HSTs may have a variety of features. In some embodiments, for example, an HST may comprise a temperature-activated adhesive lining an interior surface, causing the HST to adhere to a wire or cable when it shrinks, and helping ensure a seal is formed between the HST and wire or cable. In some embodiments, the temperature-activated adhesive may not be included with the HST, but may be applied prior to use. Some HSTs may comprise “two-segment” HSTs, where a first HST member covers one underlying structure (e.g., wire or cable), and a second HST member covers another underlying structure that may have different physical dimensions (e.g., a thicker wire, crimp, etc.). The first and second HST members overlap such that, after shrinking, the first and second HST members encapsulate the underlying structures and also overlap such that one HST member is partially encapsulated by the other, thereby creating a continuous seal over all underlying structures. Some HSTs may be made of a pliable material that helps form a seal between a structure encapsulated by the HST, and another structure at least partially encapsulating the HST. For example, according to some embodiments, HSTs may be used to encapsulate stripped and un-stripped portions of branch cables 511 to form a primary seal against the insulated (un-stripped) portions of the branch cables 511. The HSTs may also provide a more pliable surface (e.g., compared with the insulator of the uninsulated portions) against which an inner mold 210 can form a secondary seal. Thus, in such embodiments, HSTs not only may be used to provide a seal directly over exposed wires it (and/or other conductive surfaces), but also help facilitate a seal of encapsulated portions of a trunk bus system by an inner mold 210.

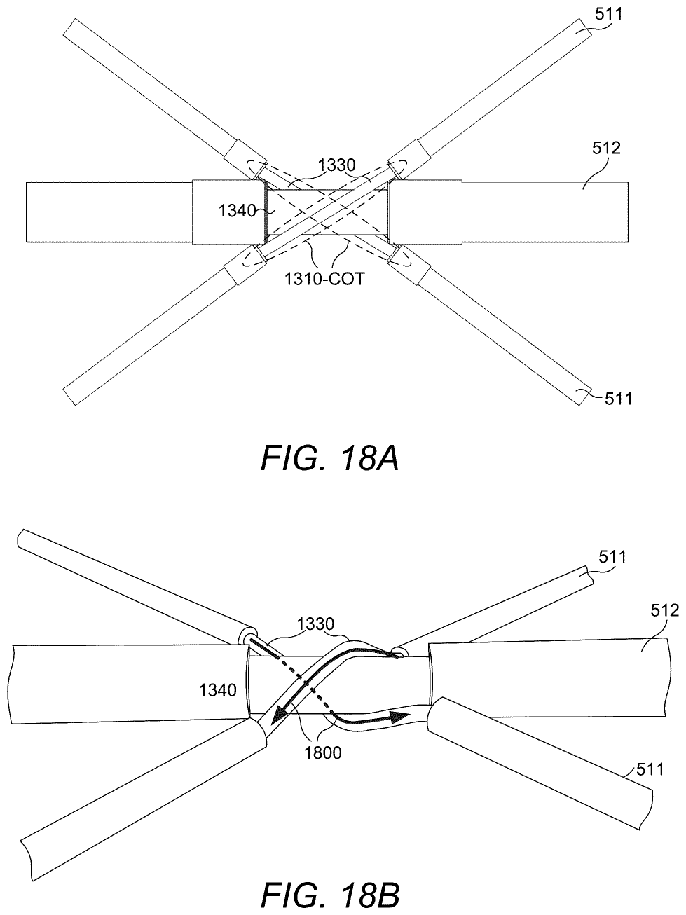

FIGS. 18A and 18B are illustrations of a configuration with two branch cables 511 and a trunk line 512, prior to crimping. These figures may correspond with the configuration shown in FIG. 13A and are similarly labeled. Specifically, stripped portions of the branch cables 1330 form a crossover through connection 1310 with a stripped portion of the trunk line 1340. FIG. 18A provides an overhead view and FIG. 18B provides a perspective view. As shown by the arrows 1800 in FIG. 18B, the stripped portions of the two branch cables 1330 following a helical route around the circumference of the stripped portion of the trunk line 1340. As described in more detail below, a crimp may be designed to ensure the stripped portions of the two branch cables 1330 are secured to the stripped portion of the trunk line 1340 in this manner.

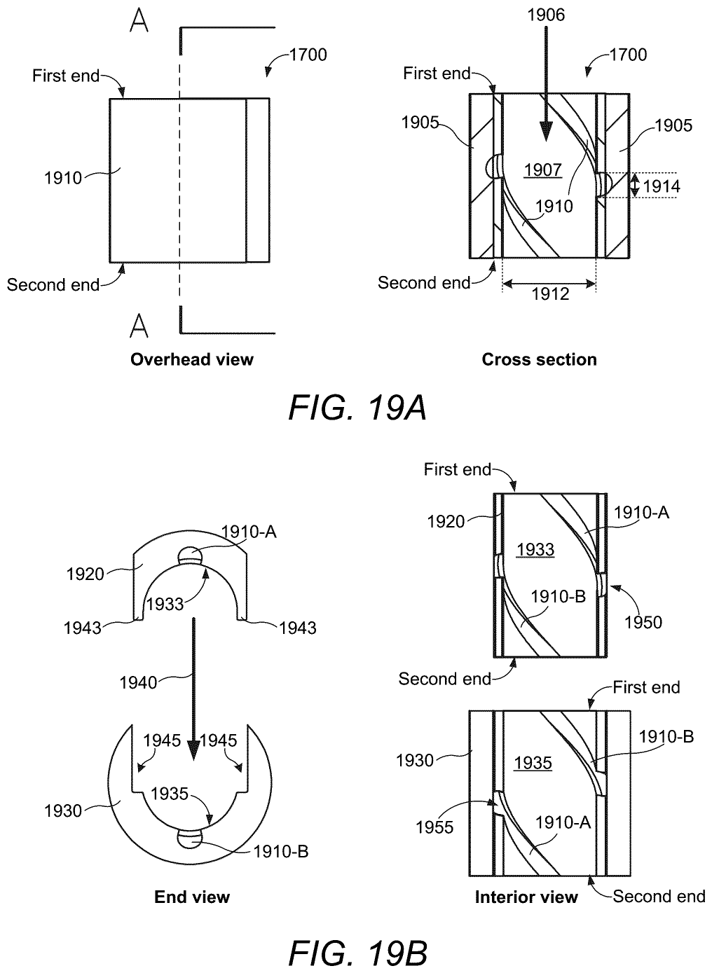

FIGS. 19A and 19B are illustrations of a crimp 1700, according to an embodiment. For convention in this disclosure, a first end and a second end of the crimp 1700 have been labeled. It can be noted that other view or orientation descriptors are used below however these are also used for convention. The crimp 1700 may be used as needed in any suitable orientation.

As indicated, FIG. 19A includes an overhead view and a cross-section view of the crimp 1700, according to an embodiment, which may be used with the trunk bus connector 1200 described above. As indicated, the overhead view illustrates an A-A section of the crimp 1700 corresponding to the cross-sectional view.

According to this embodiment, the crimp 1700 has a tubular body with sidewalls 1905 forming a channel extending from the first end to the second and through which a stripped portion of a trunk line can run. (Arrow 1906 indicates a pathway through the channel.) As further illustrated, an inner surface 1907 of the crimp surrounding the channel may include one or more grooves 1910, which run alongside the channel (e.g., in the direction of arrow 1906) in a helical pattern. Stripped portions of branch cables may run through these grooves 1910, which can help secure the stripped portions of the branch cables to the stripped portion of the trunk line in the manner illustrated in FIGS. 18A and 18B. The grooves 1910 illustrated in FIG. 19A represents portions of two separate grooves, each extending from the first end to the second end of the crimp 1700. Additional details our shown in FIG. 19B, described below. (It is noted that because the cross-section of the crimp 1700 shown in FIG. 19A is not perpendicular to grooves 1910, the “diameter” of grooves 1910 represented by arrows 1914 may represent an approximation of the true diameter of grooves 1910. The discussion below referring to diameter 1914 is intended to refer the true diameter of the grooves 1910.)

Dimensions of the crimp may vary depending on the size of the trunk line and/or branch cable(s). For example, according to some embodiments, the diameter 1912 of the channel may be 20 mm±0.5 mm. According to some embodiments, the diameter 1914 of the grooves 1910 may be 5 mm±0.5 mm. More broadly, according to some embodiments, the diameter of 1912 may fall within a range of 9 mm to 35 mm, and the diameter of 1914 may fall within a range of 5 mm to 8 mm. These values may be within a degree of tolerance (e.g., 0.5 mm), to allow for a degree of variability in the manufacturing process. Further, according to some embodiments, the ratio of the diameter of 1914 to the diameter of 1912 may range from 1:7 to 5:9, depending on the size of the trunk line and/or branch cable(s). (It will be understood that these sizes and ratios are provided as nonlimiting examples; some embodiments may use sizes and/or ratios other than those explicitly provided herein.) Put generally, the diameters 1912 and 1914 may be approximately the diameters of the trunk line and branch cable(s), respectively. This can enable an installer to place the stripped portion of the trunk line in the channel and stripped portions of the branch cables into the grooves 1910 prior to crimping.

FIG. 19B includes an end view and interior view of components of the crimp 1700, according to an embodiment. As illustrated, the crimp may comprise nested c-crimps comprising a smaller c-crimp 1920 and a larger c-crimp 1930, each comprising a semi-cylindrical member that, when mated with the other, forms the tubular body of the crimp 1700. The end view is a view of the smaller c-crimp 1920 and the larger c-crimp 1930 from an end (e.g., the first end) of the crimp 1700, and the interior view is a view of the interior surface 1933 of the smaller c-crimp 1920 and the interior surface 1935 of the larger c-crimp 1930.

As shown by the end view, the smaller c-crimp 1920 may be mated to the larger c-crimp 1930 as shown by arrow 1940. When mated, each 1943 of the smaller c-crimp fits into a corresponding groove 1945 (not to be confused with grooves 1910 for the branch cables).

The interior view distinguishes the labels of the helical grooves to help illustrate how the grooves of the smaller c-crimp 1920 and the larger c-crimp 1930 form two separate helical grooves 1910-A and 1910-B that extend from the first end to the second end. For example, with respect to groove 1910-A, when the smaller c-crimp 1920 and the larger c-crimp 1930 are mated, opening 1950 in the smaller c-crimp 1920 fits with opening 1955 of the larger c-crimp 1930, forming a single groove 1910-A extending from the first end to the second end. The second groove 1910-B is formed similarly. (The ends of these grooves 1910-A and 1910-B from the perspective of the first end are illustrated in the end view in FIG. 19B.)

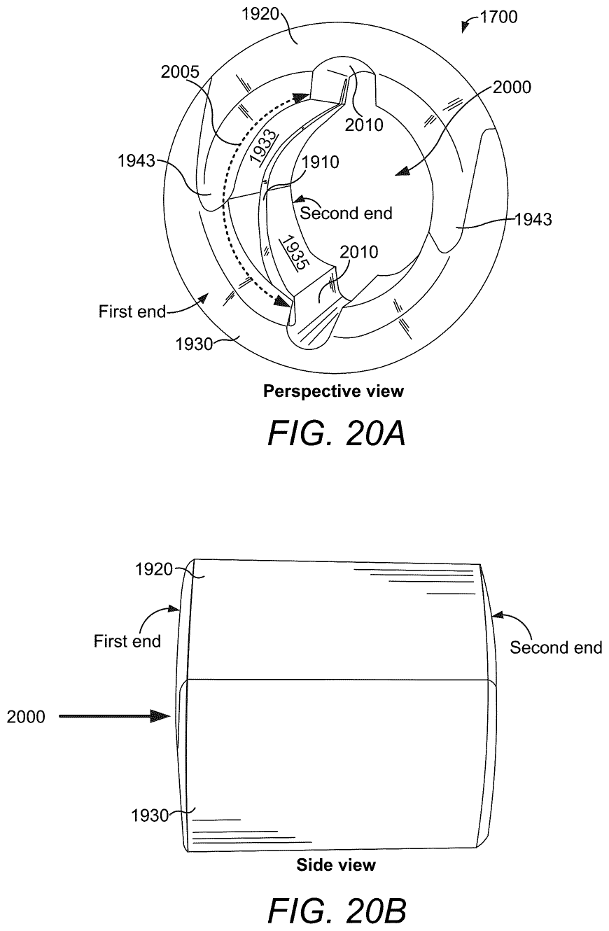

FIGS. 20A and 20B are illustrations of a perspective and side view of another embodiment of a crimp 1700, respectively. Various components of the crimp 1700 are labeled to match the corresponding labels in FIGS. 19A and 19B. Further, the perspective view of FIG. 20A provides a clear illustration of how a tubular body of the crimp 1700 forms a channel 2000, through which the stripped portion of the trunk line can pass. The side view of the crimp 1700 shown in FIG. 20B shows the cylindrical shape of the tubular body. The channel 2000 may be substantially aligned with a trunk line pathway in the overmold of the trunk bus connector to allow the trunk line to pass through both of the overmold and the crimp 1700 of the connector. Further, because of the angle of the perspective view in FIG. 20, only a single helical groove 1910 is illustrated, although the crimp 1700 may include a similar groove (not visible) on the other side of the channel 2000.

FIG. 20A also illustrates a clear path of the groove 1910. More specifically, it illustrates how the groove 1910 runs helically at least partially around a circumference of the channel 2000, as illustrated by arrow 2005. In this embodiment, the groove 1910 runs in a helical manner substantially 180° circumferentially around the channel. This groove 1910 (and another groove, not visible, on the opposite side of the channel 2000) may allow a branch cable to make a crossover through connection in the manner described in the embodiments above by enabling one or more branch cables to enter a first end of the tubular body of the crimp 1700 and exiting a second and of the tubular body opposite to the first end.

It can be noted that there are at least two differences in the embodiment of the crimp 1700 illustrated in FIGS. 20A and 20B from the embodiment illustrated in FIGS. 19A and 19B. First, the tongue 1943 (and corresponding groove) in the embodiment illustrated in FIG. 20A has a curved profile. In the embodiments illustrated in FIGS. 19A and 19B, the tongue has a substantially straight profile. This illustrates how various embodiments may allow a smaller c-crimp 1920 to mate with a larger c-crimp 1930 in different ways. Moreover, other embodiments may have additional or alternative tongue-and-groove profiles and/or other mechanisms to allow the coupling of different portions of the crimp 1700. It may further be noted that alternative embodiments of a crimp 1700 may have a single member that does not involve coupling components or may have more than two coupling components. The number of components and/or the profile of the tongue 1943 may depend on manufacturing concerns, materials used, and/or other considerations.

A second difference in the embodiment of the crimp 1700 includes the addition of grooves 2010. As illustrated, grooves 2010 may run substantially parallel to the channel 2000, and may be located on opposite sides of the channel 2000. This can allow for same-side through and terminal connections as described herein. Moreover, as illustrated, the use of straight grooves 2010 may be combined with the use of helical grooves 1910, as illustrated, such that the ends of the grooves meet at a common point at the end of the crimp 1700. The use of both straight and helical grooves in this manner can allow for a single crimp 1700 design that allows for the various configurations illustrated in FIGS. 13A-15D, described above. More specifically, the embodiment of the crimp 1700 of FIGS. 20A and 20B may accommodate crossover through connections, same-side through connections, and/or terminal connections of one or more branch cables with a trunk line.

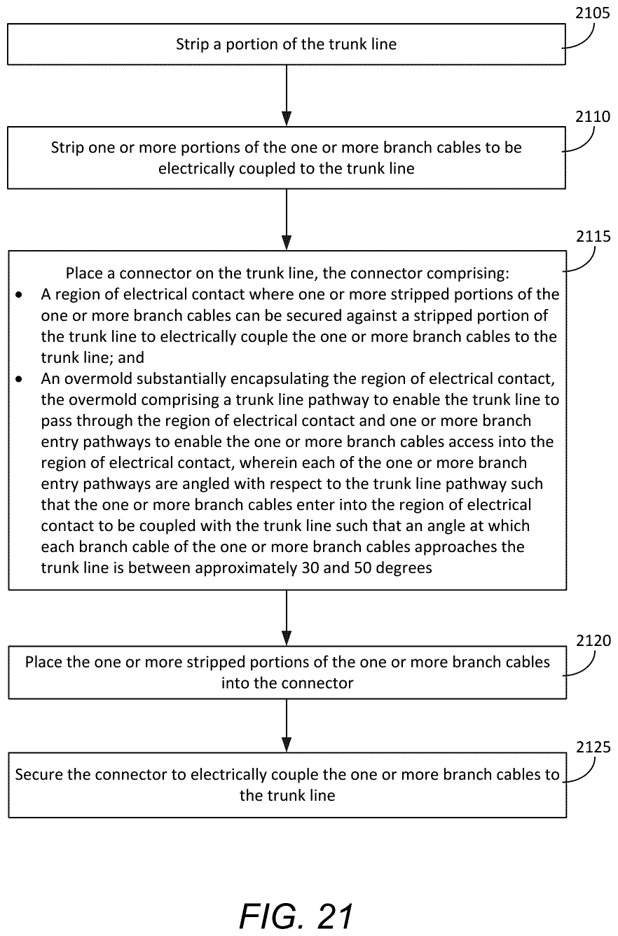

FIG. 21 is a flowchart of a method of electrically coupling one or more branch cables to a trunk line, according to an embodiment. In some aspects, this method may be seen as using the trunk bus connector 1200 described herein, including the various configurations illustrated in FIGS. 13A-15D and embodiments of the crimp 1700 described herein. Accordingly, this method may be performed, for example, by a technician in the field when using the trunk bus connector 1200 in the deployment and/or maintenance of a solar power system.

At block 2105, the functionality comprises stripping a portion of the trunk line. This may be performed with the help of a wire stripping tool, for example. The stripped portion of the trunk line may correspond to the stripped portion of the trunk line 1340 as described herein with respect to FIGS. 13A-13F, for example.

At block 2110, the functionality comprises stripping one or more portions of the one or more branch cables to be electrically coupled to the trunk line again, this may be performed with the help of a wire stripping tool, for example. The stripped portion of the trunk line may correspond to the various connections 1310 (e.g., 1310-COT, 1310-SST, 1310-T) as described herein with respect to FIGS. 13A-15D, for example.

At block 2115, the functionality comprises placing a connector on the trunk line, the connector comprising (i) a region of electrical contact where one or more stripped portions of the one or more branch cables can be secured against a stripped portion of the trunk line to electrically couple the one or more branch cables to the trunk line; and (ii) an overmold substantially encapsulating the region of electrical contact, the overmold comprising a trunk line pathway to enable the trunk line to pass through the region of electrical contact and one or more branch entry pathways to enable the one or more branch cables access into the region of electrical contact, wherein each of the one or more branch entry pathways are angled with respect to the trunk line pathway such that the one or more branch cables enter into the region of electrical contact to be coupled with the trunk line such that an angle at which each branch cable of the one or more branch cables approaches the trunk line is between approximately 30 and 50 degrees. As indicated in the above-described embodiments, an overmold (e.g., overmold 111) of a trunk bus connector can help ensure electrical conductivity the region of electrical contact, or junction area. In some embodiments, this may be done with the help of an undermold (e.g., undermold layer 210) and/or crimp (e.g., crimp 1700).

The functionality at block 2120 comprises placing the one or more stripped portions of the one or more branch cables into the connector. This can be done using a desired configuration, such as one of the configurations shown in FIGS. 13A-15D, for example. Further, as noted herein, the overmold (and undermold/crimp, if used) may be designed to accommodate the particular or various configurations.

The functionality at block 2125 comprises securing the connector to electrically couple the one or more branch cables branch cables to the trunk line. This may include, for example, closing the overmold, closing the undermold (if used), and/or crimping the crimp (if used).

Embodiments of the method illustrated in FIG. 21 may include one or more additional features, if desired as described in the embodiments herein. For example, according to some embodiments, the crimp may comprise a substantially tubular body forming a channel through which the stripped portion of the trunk line can pass. (See, for example, FIGS. 20A and 20B.) In such embodiments, the channel may be substantially aligned with the trunk line pathway of the overmold. (Compare the alignment of crimp 1700 in FIG. 17A with overmold 111 in FIG. 12, for example.) In some embodiments, the crimp may comprise two semi-cylindrical members that, when mated, form the tubular body. An example of this is illustrated in FIG. 19B, described above. In such embodiments, a first member of the two semi-cylindrical members may have at least one tongue that fits into a corresponding groove of a second member of the two semi-cylindrical members when the first member is mated with the second member. Additionally or alternatively, the tubular body may further comprise one or more grooves alongside the channel for the stripped portions of the one or more branch cables, the one or more grooves configured to secure the one or more stripped portions of the one or more branch cables against the stripped portion of the trunk line in the channel. Examples of such grooves are shown in FIGS. 19A-20B (e.g., grooves 1910 and 2010).

Following the long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments +50%, in some embodiments ±20%, in some embodiments +10%, in some embodiments ±5%, in some embodiments +1%, in some embodiments ±0.5%, and in some embodiments +0.1% from the specified amount, as such variations are appropriate to perform the disclosed methods or employ the disclosed compositions. The terms “substantially” and “approximately” may be interpreted in a similar manner when referring to a value.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. The terms “substantially” and “approximately” may be interpreted in a similar manner when referring to a value.

Although the foregoing subject matter has been described in some detail by way of illustration and example for purposes of clarity of understanding, it will be understood by those skilled in the art that certain changes and modifications can be practiced within the scope of the appended claims.

What is claimed is:

1. A trunk bus connector for electrically coupling one or more branch cables to a trunk line, the connector comprising:
a region of electrical contact where one or more stripped portions of the one or more branch cables can be secured by the connector against a stripped portion of the trunk line to electrically couple the one or more branch cables to the trunk line; and
an overmold substantially encapsulating the region of electrical contact, the overmold comprising a trunk line pathway to enable the trunk line to pass through the region of electrical contact and one or more branch entry pathways to enable the one or more branch cables access into the region of electrical contact, wherein each of the one or more branch entry pathways are angled with respect to the trunk line pathway such that the one or more branch cables enter into the region of electrical contact to be coupled with the trunk line such that an angle at which each branch cable of the one or more branch cables approaches the trunk line is between approximately 30 and 50 degrees.

2. The trunk bus connector of claim 1, wherein the connector is configured to secure the one or more stripped portions of the one or more branch cables against the stripped portion of the trunk line such that the one or more stripped portions of the one or more branch cables are substantially non-parallel to the stripped portion of the trunk line in the region of electrical contact.

3. The trunk bus connector of claim 2, wherein the connector is configured to secure the one or more stripped portions of the one or more branch cables against the stripped portion of the trunk line such that the one or more stripped portions of the one or more branch cables extend helically at least partially around a circumference of the stripped portion of the trunk line in the region of electrical contact.

4. The trunk bus connector of claim 1, further comprising a crimp configured to secure the one or more stripped portions of the one or more branch cables and the stripped portion of the trunk line together.

5. The trunk bus connector of claim 4, wherein the crimp comprises a substantially tubular body forming a channel through which the stripped portion of the trunk line can pass, wherein the channel is substantially aligned with the trunk line pathway of the overmold.

6. The trunk bus connector of claim 5, wherein the crimp comprises two semi-cylindrical members that, when mated, form the tubular body.

7. The trunk bus connector of claim 6, wherein a first member of the two semi-cylindrical members has at least one tongue that fits into a corresponding groove of a second member of the two semi-cylindrical members when the first member is mated with the second member.

8. The trunk bus connector of claim 5, wherein the tubular body further comprises one or more grooves alongside the channel for the stripped portions of the one or more branch cables, the one or more grooves configured to secure the one or more stripped portions of the one or more branch cables against the stripped portion of the trunk line in the channel.

9. The trunk bus connector of claim 8, wherein at least one of the one or more grooves run substantially non-parallel to the channel.

10. The trunk bus connector of claim 8, wherein at least one of the one or more grooves run helically at least partially around a circumference of the channel.

11. The trunk bus connector of claim 10, wherein the at least one of the or more grooves run in a helical manner substantially 180 degrees circumferentially around the channel.

12. The trunk bus connector of claim 8, wherein the one or more grooves run from one end of the channel to the other end of the channel, enabling a stripped portion one of the one or more branch cables to enter a first end of the tubular body and exit a second end of the tubular body opposite to the first end.

13. A method of electrically coupling one or more branch cables to a trunk line, the method comprising:
stripping a portion of the trunk line;
stripping one or more portions of the one or more branch cables to be electrically coupled to the trunk line;
placing a connector on the trunk line, the connector comprising:
a region of electrical contact where one or more stripped portions of the one or more branch cables can be secured by the connector against a stripped portion of the trunk line to electrically couple the one or more branch cables to the trunk line; and
an overmold substantially encapsulating the region of electrical contact, the overmold comprising a trunk line pathway to enable the trunk line to pass through the region of electrical contact and one or more branch entry pathways to enable the one or more branch cables access into the region of electrical contact, wherein each of the one or more branch entry pathways are angled with respect to the trunk line pathway such that the one or more branch cables enter into the region of electrical contact to be coupled with the trunk line such that an angle at which each branch cable of the one or more branch cables approaches the trunk line is between approximately 30 and 50 degrees;
placing the one or more stripped portions of the one or more branch cables into the connector; and
securing the connector to electrically couple the one or more branch cables to the trunk line.

14. The method of claim 13, wherein the connector further comprises a crimp configured to secure the one or more stripped portions of the one or more branch cables and the stripped portion of the trunk line together.

15. The method of claim 14, wherein the crimp comprises a substantially tubular body forming a channel through which the stripped portion of the trunk line can pass, wherein the channel is substantially aligned with the trunk line pathway of the overmold.

16. The method of claim 15, wherein the crimp comprises two semi-cylindrical members that, when mated, form the tubular body.

17. The method of claim 15, wherein the tubular body further comprises one or more grooves alongside the channel for the stripped portions of the one or more branch cables, the one or more grooves configured to secure the one or more stripped portions of the one or more branch cables against the stripped portion of the trunk line in the channel.

18. A crimp for electrically coupling one or more branch cables to a trunk line, the crimp comprising:
a substantially tubular body configured to secure one or more stripped portions of the one or more branch cables and the stripped portion of the trunk line together, the tubular body forming a channel through which the stripped portion of the trunk line can pass, wherein:
the crimp comprises two semi-cylindrical members that, when mated, form the tubular body; and
the tubular body further comprises one or more grooves alongside the channel for the stripped portions of the one or more branch cables, the one or more grooves configured to secure the one or more stripped portions of the one or more branch cables against the stripped portion of the trunk line in the channel.

19. The crimp of claim 18, wherein a first member of the two semi-cylindrical members has at least one tongue that fits into a corresponding groove of a second member of the two semi-cylindrical members when the first member is mated with the second member.

20. The crimp of claim 18, wherein at least one of the one or more grooves run helically at least partially around a circumference of the channel.
